(19) United States
(12) Patent Application Publication
(10) Pub. No.: US 2004/0222552 A1
(43) Pub. Date: Nov. 11, 2004

(54) Three-dimensional fabrics and films and the process for making the same

(76) Inventors: John Housler, Charlotte, NC (US); Ralph Moody III, Mooresville, NC (US); Nick Carter, Mooresville, NC (US); Robert Dale, Lawrenceville, GA (US); James Schaeffer, Charleston, SC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/762,910

(22) Filed: Jan. 22, 2004

Related U.S. Application Data
(60) Provisional application No. 60/441,828, filed on Jan. 22, 2003.

(51) Int. Cl. B29C 47/06

(52) U.S. Cl. 264/171.13

(57) ABSTRACT

The present invention is directed to a method of making three-dimensionally imaged films, and more specifically to a method of making an imaged film by directly extruding the polymeric melt onto a three-dimensional surface. The present invention is further directed to a method of making three-dimensionally imaged nonwoven fabric comprising at least one layer of continuously extruded nonwoven filaments that are directly deposited onto the foraminous surface of a three-dimensional image transfer device.

### THREE-DIMENSIONAL FILMS AND THE PROCESS FOR MAKING THE SAME TECHNICAL BACKGROUND

The present invention generally refers to a method of making three-dimensionally imaged fabrics and films, and more specifically to a method of making an imaged film by directly extruding the polymeric melt onto a three-dimensional surface.

### BACKGROUND OF THE INVENTION

Films are used in a wide variety of applications where the engineered qualities of the film can be advantageously employed. The use of selected thermoplastic polymers in the construction of film products, selected treatment of the polymeric films (either while in melt form or in an integrated structure), and selected use of various mechanisms by which the film is integrated into a useful construct, are typical variables by which to adjust and alter the performance of the resultant polymeric film product.

The formation of finite thickness films from thermoplastic polymers is a well known practice. Thermoplastic polymer films can be formed by either dispersion of a quantity of molten polymer into a mold having the dimensions of the desired end product, known as a thermo-formed or injection-molded film, or by continuously forcing the molten polymer through a die, known as an extruded film. Extruded thermoplastic polymer films can either be formed such that the film is cooled then wound as a completed product, or dispensed directly onto a substrate material to form a composite material having performance of both the substrate and the film layers. Examples of suitable substrate materials include other films, polymeric or metallic sheet stock and woven or nonwoven fabrics.

It has recently become desirable to impart a three-dimensional image into a polymeric film. A reticulated film is a film that offers some degree of three-dimensionality, wherein the process of making such a film is disclosed in U.S. Pat. No. 4,381,326, to Kelly. The reticulated film surface of the nonwoven fabric construct is comprised of a series of depressions that are imparted into the film causing reticulated holes. The depressions within the film provide the resultant film with a three-dimensional aesthetic quality.

Polymeric films have proven to be particularly suitable for a variety of medical, hygiene, and industrial applications as such constructs permit cost-effective, disposable use. Use of such materials for surgical drapes, medical wipes, and the like has become increasingly widespread, since the physical properties and characteristics of the film can be selected as may be required for specific medical applications. Further, a film laminate structure may be used for such aforementioned applications, wherein the film is combined with a nonwoven or an additional film layer.

There is an unmet need for a method of making three-dimensionally imaged polymeric films that comprise an improved aesthetic quality, as well as an improved product performance. Further, a need remains for a method of making a low cost three-dimensional film, but one that can be ran at high potential speeds of at least 300 feet per minute.

Nonwoven fabrics are used in a wide variety of applications where the engineered qualities of the fabrics can be advantageously employed. The use of selected thermoplastic polymers in the construction of the fibrous fabric component, selected treatment of the fibrous component (either while in fibrous form or in an integrated structure), and selected use of various mechanisms by which the fibrous component is integrated into a useful fabric, are typical variables by which to adjust and alter the performance of the resultant nonwoven fabric.

In and of themselves, continuous filament substrate materials, referred to as “spunbond”, are relatively highly porous, and ordinarily require an additional component in order to achieve the required barrier performance. Typically, barrier performance, as measured by hydrostatic head or porimetry, has been enhanced by the application of a barrier “meltblown” layer of micrometer scale filaments, which are drawn and fragmented by a high velocity air stream, and deposited into a self-annealing mass upon the spunbond substrate material. Typically, such a meltblown layer exhibits very low porosity, enhancing the barrier properties of compound fabrics formed with spunbond and subsequent meltblown layers. Such nonwoven constructs have been utilized as barrier fabrics as disclosed in U.S. Pat. No. 4,041,203 to Brock at al., the disclosure of which is herein incorporated by reference.

More recently, techniques have been developed which impart images or patterns to nonwoven fabrics by exposing the fabric to a three-dimensional image transfer device. Such three-dimensional image transfer devices are disclosed in U.S. Pat. No. 5,098,764, which is hereby incorporated by reference; with the use of such image transfer devices being desirable for providing a fabric with enhanced physical properties as well as an aesthetically pleasing appearance.

The present invention contemplates a method of making a nonwoven fabric comprising continuously formed filaments wherein the molten polymer directly extruded onto the surface a three-dimensional image transfer device.

### SUMMARY OF THE INVENTION

The present invention is directed to a method of making three-dimensionally imaged films, and more specifically to a method of making an imaged film by directly extruding the polymeric melt onto a three-dimensional surface.

In accordance with the present invention, a thermoplastic film is advanced onto a foraminous surface and impinged with hydraulic energy so as to impart an image or pattern into the film. In a preferred embodiment, the foraminous surface is a three-dimensional image transfer device. A three-dimensional image transfer device (ITD) is configured generally in accordance with the teachings of U.S. Pat. No. 5,098,764, to Drelich et al., hereby incorporated by reference.

The film substrate may be that of various olefinic thermoplastic polymers including, but are not limited to, isotactic polypropylene, linear low-density polyethylene, low-density polyethylene, high-density polyethylene, amorphous polypropylene, polybutylene, ethylene/vinyl acetate copolymer, ethylene/ethyl acrylate copolymer, ethylene/methyl acrylate copolymer, polystyrene, and the combination thereof.

In first embodiment, a polymeric film is directly extruded onto an ITD, wherein the ITD is comprised of a supporting vacuum roll. The vacuum roll provides a necessary amount of suction so as to aperture the molten film, as well as impart a three-dimensional surface into the apertured film. Subsequently, the film may be treated with a performance enhancing chemistry, such as a hydrophobic or hydrophilic additive or an aesthetic enhancing chemistry, such as a thermochromic additive.

In a second embodiment, at least one supporting substrate is utilized, wherein the polymeric film is extruded onto the supporting substrate. Suitable support substrates include various porous staple fiber webs or continuous filamentary webs, which may be planar or non-planar in formation, as well as apertured or non-apertured. In accordance with the present invention, the molten film is extruded onto the supporting substrate, which is positioned on the ITD, and integrated into the fibrous or filamentary network by the mechanical means of the vacuum roll. The adhesion of the film to the supporting substrate is greatly improved due the integration of the film into the supporting substrate.

It is also in the purview of the invention that the film and/or the supporting substrate undergo various post treatments subsequent to imaging. For instance, the film may be drawn so as to create microporous fissures started by the vacuum roll ITD surface, hydroentangled on a planar or non-planar ITD surface, embossed, and/or finished by various mechanisms known to those in the art.

The present invention is further directed to a method of making three-dimensionally imaged nonwoven fabric comprising at least one layer of continuously extruded nonwoven filaments that are directly deposited onto the foraminous surface of a three-dimensional image transfer device.

In accordance with the present invention, the nonwoven fabric is comprised of at least one layer of continuous filamentary webs. Further, the fabric may comprise at least one supporting substrate. Suitable support substrates include various porous staple fiber webs or continuous filamentary webs, which may be planar or non-planar in formation, as well as apertured or non-apertured.

The thermoplastic polymers of the continuous filament web may be chosen from the group consisting of polyolefins, polyamides, and polyesters, wherein the polyolefins are chosen from the group consisting of polypropylene, polyethylene, and combinations thereof. It is within the purview of the present invention that the continuous filament web or webs may comprise either the same or different thermoplastic polymers. Further, the continuous filaments may comprise homogeneous, bicomponent, and/or multi-component profiles, as well as, performance modifying additives, and the blends thereof.

Other features and advantages of the present invention will become readily apparent from the following detailed description, the accompanying drawings, and the appended claims.

### BRIEF DESCRIPTION OF THE DRAWINGS

FIG. 1 is a schematic representation of the processing apparatus for producing a film or an imaged continuous filament fabric in accordance with the principles of the present invention;

FIG. 2 is a schematic representation of the three-dimensional image transfer device for producing an imaged film in accordance with the principles of the invention;

FIG. 3 is a photomicrograph of an imaged film made in accordance with the principles of the present invention;

FIG. 4 is an alternate view of FIG. 3 made in accordance with the principles of the present invention;

FIG. 5 is a photomicrograph of an imaged film made in accordance with the principles of the present invention;

FIG. 6 is a photomicrograph of an imaged film laminate made in accordance with the principles of the present invention; and

FIG. 7 is an alternate view of FIG. 6 made in accordance with the principles of the present invention.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

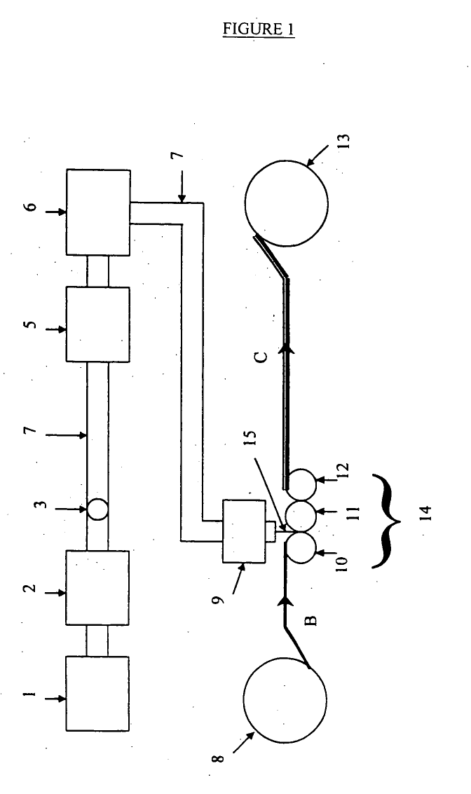

FIG. 1 depicts a representative direct extrusion film process. Blending and dosing system 1, comprising at least two hopper loaders for polymer chip and a mixing hopper. Variable speed augers within both hopper loaders transfer predetermined amounts of polymer chip and additive pellet to the mixing hopper. The mixing hopper contains a mixing propeller to further the homogeneity of the mixture. Basic volumetric systems such as that described are a minimum requirement for the blending zone system.

The polymer chip and additive pellet blend feeds into a multi-zone extruder 2 as supplied by the Wellex Corporation. In this particular system, a five zone extruder was employed with a 2 inch water-jacketed bore and a length to diameter ratio of 24 to 1.

Upon mixing and extrusion from multi-zone extruder 2, the polymer compound is conveyed via heated polymer piping 7 through screen changer 3, wherein breaker plates having different screen meshes are employed to retain solid or semi-molten polymer chips and other macroscopic debris. The mixed polymer is then fed into melt pump 5.

Melt pump 5 operates in dynamic feed back with the multi-zone extruder 2 to maintain the desired pressure levels. A gear-type melt pump was employed to respond to pressure levels by altering the speed of the extruder to compensate for deviations from the pressure set point window.

The metered and mixed polymer compound then enters combining block 6. The combining block allows for multiple film layers to be extruded, the film layers being of either the same composition or fed from different systems as described above. The combining block 6 is directed into die body 9 by additional heated polymer piping 7.

The particular die body 9 employed in this system is a 37 inch wide EDI Automatic Die with die bolt control as supplied by EDI. The die body 9 is positioned in an overhead orientation such that molten film extrusion 15 is deposited at the nip point in cast station 14, between nip roll 10 and cast roll 11.

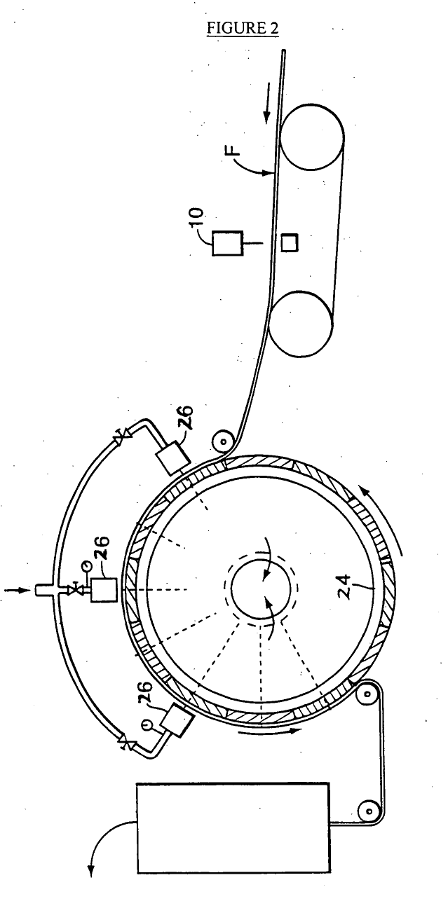

FIG. 2 depicts the means for imparting the three-dimensional quality into the film during the manufacturing process. FIG. 2 includes an imaging and patterning drum 24 comprising a three-dimensional image transfer device (ITD) for effecting imaging and patterning of the film substrate.

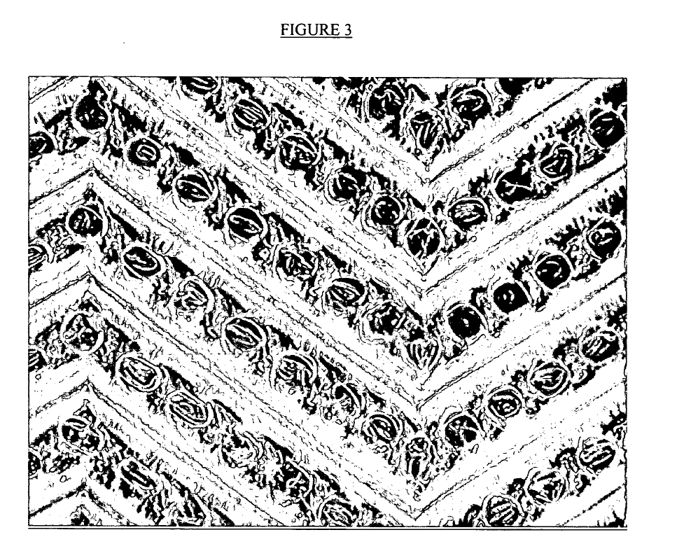

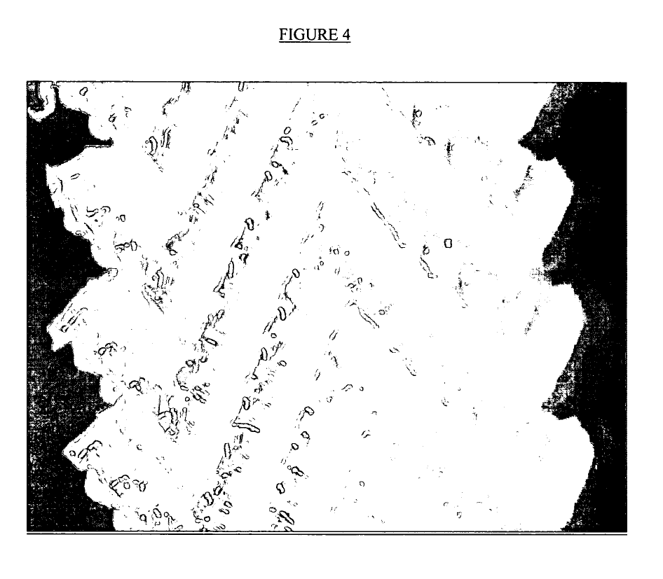

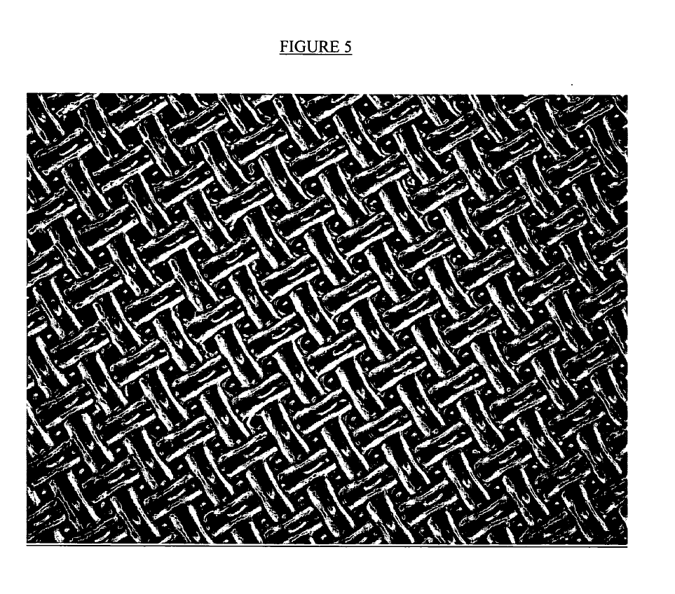

In first embodiment, a polymeric film is directly extruded onto the ITD, wherein the ITD is comprised of a supporting vacuum roll. The vacuum roll provides a necessary amount of force so as to aperture the molten film, as well as impart a three-dimensional surface into the apertured film. Subsequently, the film may be treated with a performance enhancing chemistry, such as a hydrophobic or hydrophilic additive or an aesthetic enhancing chemistry, such as a thermochromic additive. FIGS. 3-5 illustrate thee-dimensionally imaged films made in accordance with the principles of the present invention.

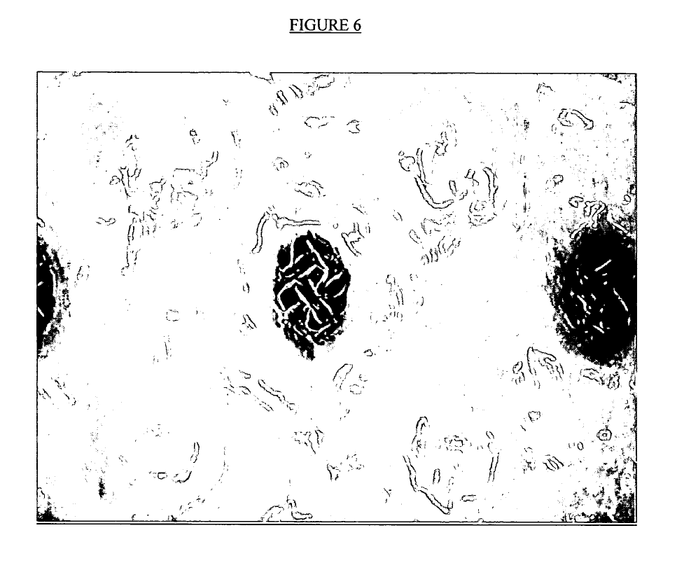

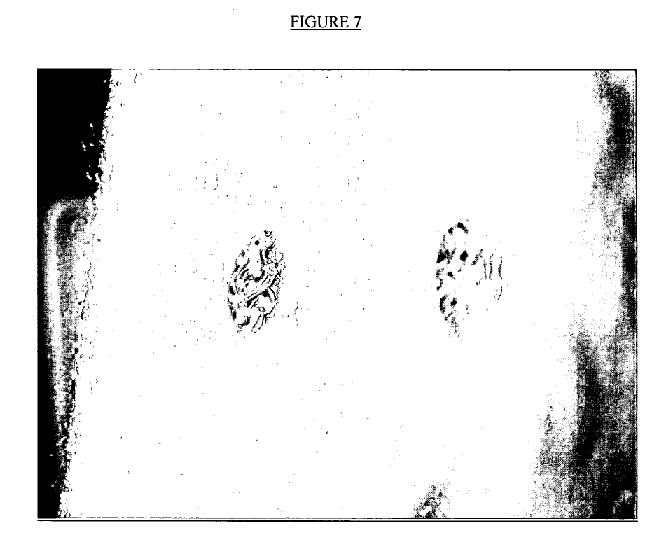

In a second embodiment, at least one support layer is positioned onto the ITD, wherein the polymeric film is extruded onto the support layer. Suitable support layers include various porous staple fiber webs or continuous filamentary webs, which may be planar or non-planar in formation, as well as apertured or non-apertured. In accordance with the present invention, the molten film is extruded onto the support layer, which is positioned on the ITD, and integrated into the fibrous or filamentary network by the mechanical means of the vacuum roll. The adhesion of the film to the support layer is greatly improved due the integration of the film into the support layer. FIGS. 6 and 7 illustrate a three-dimensionally imaged film laminate made in accordance with the principles of the present invention.

The film substrate of the present invention may be that of various olefinic thermoplastic polymers including, but are not limited to, isotactic polypropylene, linear low-density polyethylene, low-density polyethylene, high-density polyethylene, amorphous polypropylene, polybutylene, ethylene/vinyl acetate copolymer, ethylene/ethyl acrylate copolymer, ethylene/methyl acrylate copolymer, polystyrene, and the combination thereof.

The imaged film or film laminate can be used in a variety of hygiene, medical, and industrial applications. Suitable end-uses include, but are not limited to surgical drapes, surgical gowns, medical wipes, and the like. Further, the film of the present invention is suitable for various hygienic end-uses, wherein the film may be used as a component of an absorbent article, such as fem-care products, incontinence devices, diapers, and the like.

A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent web is collected upon the uppermost surface of the previously formed web. The web is then at least temporarily consolidated, usually by means involving heat and pressure, such as by thermal point bonding. Using this bonding means, the web or layers of webs are passed between two hot metal rolls, one of which has an embossed pattern to impart and achieve the desired degree of point bonding, usually on the order of 10 to 40 percent of the overall surface area being so bonded.

The thermoplastic polymers of the continuous filament spunbond layer or layers are chosen from the group consisting of polyolefins, polyesters, polyamides, and halopolymers, with ethylene-fluorocarbon copolymers, particularly ethylene-chlorotrifluoroethylene (ECTFE), wherein the polyolefins are chosen from the group consisting of polypropylene, polyethylene, and combinations thereof. It is within the purview of the present invention that the continuous filament web or webs may comprise either the same or different thermoplastic polymers. Further, the continuous filaments may comprise homogeneous, bicomponent, and/or multi-component profiles, as well as, performance modifying additives, and the blends thereof.

Additionally the continuous filamentary web may comprise a discontinuous filament web through application of the meltblown process. The melt-blown process is a related means to the spunbond process for forming a layer of a nonwoven fabric, wherein, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first and subsequent layers through consolidation of the layers to form a composite fabric. It is also within the purview of the present invention to further include, juxtaposed to the melt-blown barrier layer, additional layers selected from the group consisting of nonwoven, fabrics, woven fabrics, films and combinations thereof.

Nano-denier filaments may be incorporated as well. Suitable nano-denier continuous filament layers can be formed by either direct spinning of nano-denier filaments or by formation of a multi-component filament that is divided into nano-denier filaments prior to deposition on a substrate layer. U.S. Pat. No. 5,678,379 and No. 6,114,017, both incorporated herein by reference, exemplify direct spinning processes practicable in support of the present invention. U.S. Pat. No. 5,678,379 and No. 6,114,017, both incorporated herein by reference, exemplify direct spinning processes practicable in support of the present invention.

FIG. 1 depicts the means for imparting the three-dimensional quality into the continuous filament web or laminate during the manufacturing process. FIG. 1 includes an imaging and patterning drum 24 comprising a three-dimensional image transfer device (ITD) for effecting imaging and patterning of the continuous filament substrate.

In accordance with the present invention, at least one layer of continuously extruded nonwoven filaments are directly deposited onto the foraminous surface of a three-dimensional image transfer device. The ITD may optionally comprise a supporting vacuum roll. The vacuum roll provides suction so as to pull the filaments through the plurality of foramina within the ITD. The nonwoven fabric is comprised of at least one layer of continuous filamentary webs. Further, the fabric may comprise at least one supporting substrate. Suitable support substrates include various porous staple fiber webs or continuous filamentary webs, which may be planar or non-planar in formation, as well as apertured or non-apertured.

Prior to extrusion, the molten polymer can be compounded with various performance enhancing melt-additives, such as thermal stabilizers, UV, anti-stats, colorants, and nucleating agents. A nucleating agent may be specifically compounded to produce a more stable spinning process, and, at equal process conditions, can produce a further increase in strength. The fabric may be exposed to further performance enhancing additives after fabric formation.

The imaged nonwoven fabric may be used in a variety of hygiene, medical, and industrial applications. Suitable end-uses include, but are not limited to surgical drapes, surgical gowns, medical wipes, absorbent article component for various fem-care products, incontinence devices, diapers, and the like. Further, the fabric may be utilized in industrial applications, including outdoor protective covers for grills, lawn equipment, and cars, or used as a battery separator, filtration device, or industrial protective apparel.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A method for making a three-dimensionally imaged film comprising the steps of:
a. providing a molten polymer;
b. providing a foraminous surface; and
c. extruding said molten polymer onto said foraminous surface forming an imaged film.

2. A method of making a three-dimensionally imaged film as in claim 1, wherein said foraminous surface is a three-dimensional image transfer device.

3. A method for making a three-dimensionally imaged film comprising the steps of:
a. providing a molten polymer;
b. providing a foraminous surface;
c. providing a retention means; and
d. extruding said molten polymer onto said foraminous surface, forming a film wherein said retention means pulls through a plurality of foramina imparting apertures and into said imaged film.

4. A method of making a three-dimensionally imaged film as in claim 3, wherein said means of retention is a vacuum.

5. A method for making a three-dimensionally imaged film comprising the steps of:
a. providing a support layer;
b. providing a molten polymer;
c. providing a foraminous surface;
e. providing a retention means;
f. positioning said support layer onto said foraminous surface; and
g. extruding said molten polymer onto said support layer, forming a film laminate wherein said retention means pulls the support layer and molten polymer through a plurality of foramina resulting in an imaged film laminate.

6. A method of making a three-dimensionally imaged film as in claim 5, wherein said support layer is selected from the group of fibrous or filamentary nonwoven, wovens, films, and the combination thereof.

7. A method for making a three-dimensionally imaged continuous filament nonwoven fabric comprising the steps of:
a. providing a molten polymer;
b. providing a three-dimensional transfer device; and
c. extruding said molten polymer onto said three-dimensional transfer device forming an imaged fabric.

8. A method for making a three-dimensionally imaged continuous filament nonwoven fabric comprising the steps of:
a. providing a support layer;
b. providing a molten polymer;
c. providing a three-dimensional image transfer device;
b. providing a retention means;
c. positioning said support layer onto said three-dimensional image transfer device; and
d. extruding said molten polymer onto said support layer, forming a laminate wherein said retention means pulls said support layer and said molten polymer through a plurality of foramina within said three-dimensional image transfer device resulting in an imaged laminate.

9. A method of making a three-dimensionally imaged continuous filament nonwoven fabric as in claim 8, wherein said means of retention is a vacuum.

10. A method of making a three-dimensionally imaged continuous filament nonwoven fabric as in claim 9, wherein said support layer is selected from the group of fibrous or filamentary nonwoven, wovens, films, and the combination thereof.
